(19) United States
(12) Patent Application Publication
(10) Pub. No.: US 2013/0162392 A1
(43) Pub. Date: Jun. 27, 2013

(54) SYSTEM AND METHOD FOR UNLOCKING SCREEN OF ELECTRONIC DEVICE

(71) Applicant: HAO-CHENG CHEN, Tu-Cheng (TW)

(72) Inventor: HAO-CHENG CHEN, Tu-Cheng (TW)

(21) Appl. No.: 13/664,430

(22) Filed: Oct. 31, 2012

(30) Foreign Application Priority Data
Dec. 22, 2011 (TW) 100148148

(51) Int. Cl. G06F 7/04

(52) U.S. Cl. 340/5.2

(57) ABSTRACT

An electronic device includes a vibration sensor. The vibration sensor senses shake of the electronic device. If the user shakes the electronic device when a screen of the electronic device is in a locked state, the electronic device detects if the vibration sensor is activated. If the vibration sensor is activated, the electronic device counts a number of activation times of the vibration sensor. If the number of the activation times of the vibration sensor is the same as a predefined number, the screen of the electronic device is unlocked.

### BACKGROUND

1. Technical Field

Embodiments of the present disclosure relate to unlocking systems and methods, and particularly to a system and a method for unlocking a screen of an electronic device.

2. Description of Related Art

A plurality of electronic devices (mobile phone, tablet personal computer, for example) provide touch screens for users. A touch screen is easy to be inadvertently activated, thus a screen lock is often adopted to avoid unintentional operations. Mostly, a user has to perform a slide operation on the screen to unlock the screen. However, too much slides may damage the screen.

### BRIEF DESCRIPTION OF THE DRAWINGS

FIG. 1 is a block diagram of one embodiment of an electronic device including an unlocking system.

FIG. 2 is a block diagram of one embodiment of function modules of the unlocking system in FIG. 1.

FIG. 3 is a flowchart illustrating one embodiment of a method for unlocking a screen of an electronic device.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

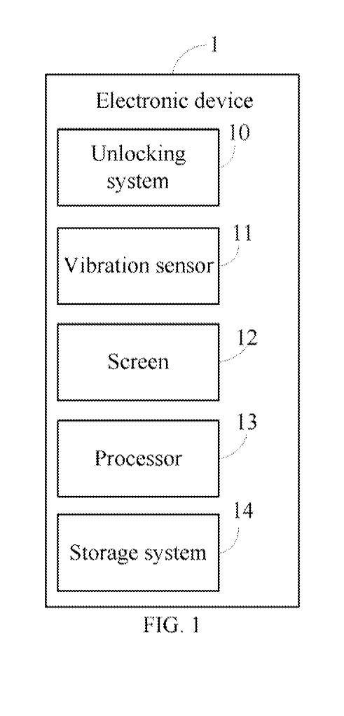

FIG. 1 is a block diagram of one embodiment of an electronic device 1 including an unlocking system 10, a vibration sensor 11 and a screen 12. In some embodiments, the electronic device 1 may be a mobile phone, a tablet personal computer, for example. The vibration sensor 11 is activated and detects vibration data of the electronic device 1 when the electronic device 1 is shaken. The vibration sensor 11 controls unlocking of the screen 12.

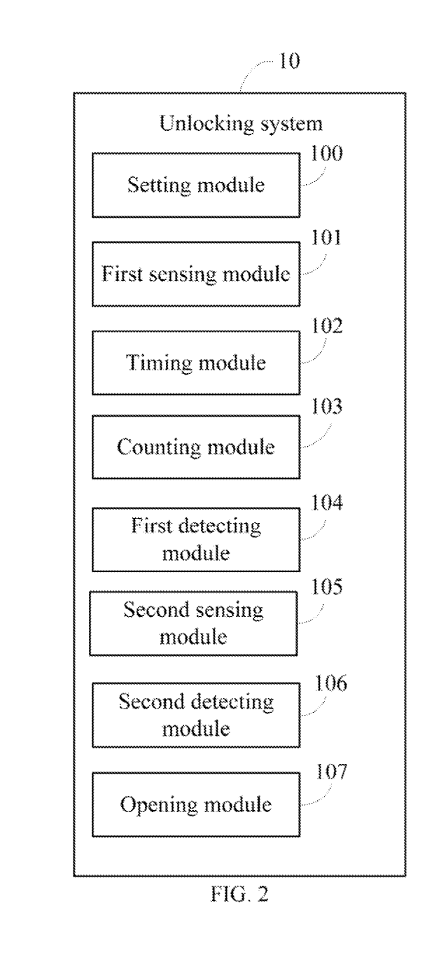

In an exemplary embodiment, the electronic device 1 includes at least one processor 13 and a storage system 14. The unlocking system 10 may include one or more modules (described in FIG. 2). The one or more modules may comprise computerized code in the form of one or more programs that are stored in the storage system 14. In one embodiment, the storage system 14 may be a magnetic storage system, an optical storage system, or other suitable storage medium. The computerized code includes instructions that are executed by the at least one processor 13 to provide functions for the one or more modules described below.

As shown in FIG. 2, the unlocking system 10 includes a setting module 100, a first sensing module 101, a timing module 102, a counting module 103, a first detecting module 104, a second sensing module 105, a second detecting module 106, and an opening module 107.

The setting module 100 sets an initial value of activation times of the vibration sensor 11. The activation times indicate how many times that the vibration sensor 11 has been activated. In one embodiment, the initial value of the activating times is zero.

The first sensing module 101 detects if the vibration sensor 11 is activated when the screen 12 is in a locked state. In one embodiment, the vibration sensor 11 may be a ball switch. The ball switch includes a ball and a circuit. If the electronic device 1 is shaken, the ball may hit the circuit. An electric level of the circuit may change if the ball hits the circuit. The vibration sensor 11 is activated because of the change of the electric level of the circuit.

If the vibration sensor 11 is activated, the timing module 102 reads a first system time of the electronic device 1. The counting module 103 increase a present value (e.g., the initial value) of the activation times of the vibration sensor 11 by one and obtains a first value of the activation times.

The first detecting module 104 calculates a difference between a second system time of the electronic device 1 and the first system time of the electronic device 1, and detects if the difference is the same as a predefined value. If the difference is different from the predefined value, the second sensing module 105 detects if the vibration sensor 11 is further activated. If the second sensing module 105 detects that the vibration sensor 11 is further activated, the counting module 103 increases the first value of the activation times by one and obtains a second value of the activation times.

If the difference is the same as the predefined value, the second detecting module 106 detects if the first value or the second value of the activation times is the same as a predefined number.

If the first value or the second value of the activation times is the same as the predefined number, the opening module 107 unlocks the screen 12 of the electronic device 1. If either the first value or the second value of the activation times is different from the predefined number, the screen 12 of the electronic device 1 remains in the locked state.

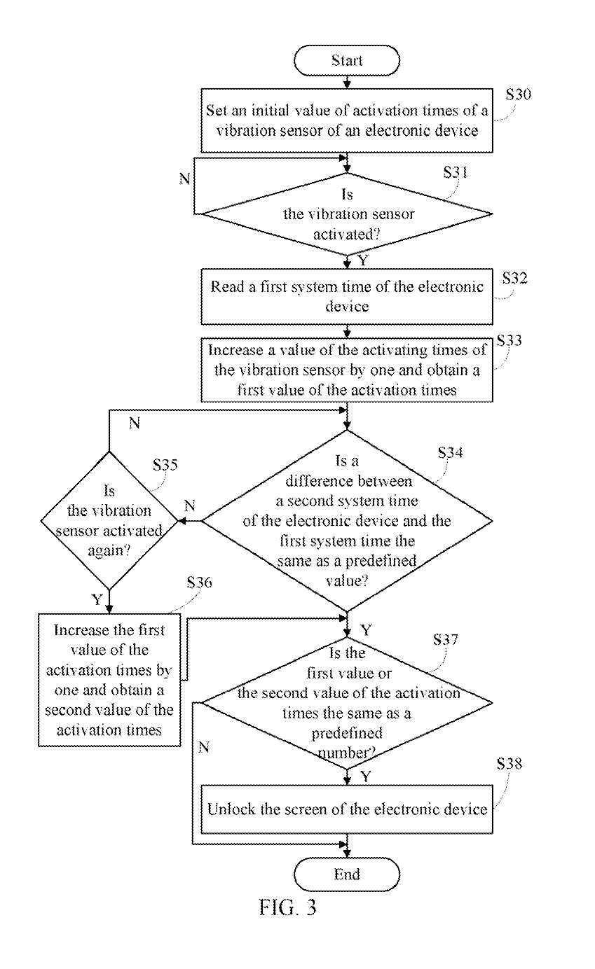

FIG. 3 is a flowchart illustrating a method for unlocking a screen of an electronic device. Depending on the embodiment, additional steps may be increased, others removed, and the ordering of the steps may be changed.

In step S30, the setting module 100 sets an initial value of an activation times of the vibration sensor 11.

In step S31, if the screen 12 is in a locked state, the first sensing module 101 detects if the vibration sensor 11 is activated. If the vibration sensor 11 is in the locked state, step S32 is implemented. If the vibration sensor 11 is not in the locked state, step S31 is repeated.

In step S32, the timing module 102 reads a first system time of the electronic device 1.

In step S33, the counting module 103 increases a present value (e.g., the initial value) of the activation times of the vibration sensor 11 by one and obtains a first value of the activation times.

In step S34, the first detecting module 104 calculates a difference between a second system time of the electronic device 1 and the first system time of the electronic device 1, and detects if the difference is the same as a predefined value. If the difference is not the same as the predefined value, step S35 is implemented. If the difference is the same as the predefined value, step S37 is implemented.

In step S35, the second sensing module 105 detects if the vibration sensor 11 is activated again. If the vibration sensor 11 is activated again, step S36 is implemented. If the vibration sensor 11 is not activated again, step S34 is repeated.

In step S36, the counting module 103 increases the first value of the activation times by one and obtains a second value of the activation times and implements step S37.

In step S37, the second detecting module 106 detects if the first value or the second value of the activation times is the same as a predefined number. If the first value or the second value of the activation times is the same as the predefined number, step S38 is implemented. If each of the first value and the second value of the activation times is not the same as the predefined number, the procedure ends.

In step S38, the opening module 107 unlocks the screen 12 of the electronic device 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a storage system;
at least one processor; and
one or more programs being stored in the storage system and executable by the at least one processor, the one or more programs comprising:
a setting module that sets an initial value of an activation times of a vibration sensor of the electronic device;
a counting module that increases the activation times by one when a screen of the electronic device is in a locked state and the vibration sensor is activated; and
an opening module that unlocks the screen when a number of the activation times is the same as a predefined number.

2. The electronic device as described in claim 1, wherein the one or more programs further comprises a timing module that reads a first system time of the electronic device when the vibration sensor is activated.

3. The computing device as described in claim 2, wherein the one or more programs further comprises:
a first detecting module that calculates a difference between a second system time of the electronic device and the first system time of the electronic device, and detects if the difference is the same as a predefined value;
a second detecting module that detects if the number of the activation times equals the predefined number when the difference is the same as the predefined value, wherein the screen of the electronic device remains in the locked state when the number of the activation times is different from the predefined number;
a second sensing module that detects if the vibration sensor is further activated again when the difference is different from the predefined value; and
the counting module that further increases the activation times by one again when the vibration sensor is activated again.

4. A method being executed by a processor of a computing device for unlocking a screen of an electronic device, comprising:
setting an initial value of an activation times of a vibration sensor of the electronic device;
increasing the activation times by one when a screen of the electronic device is in a locked state and the vibration sensor is activated; and
unlocking the screen when a number of the activation times is the same as a predefined number.

5. The method as described in claim 4, after the setting step further comprising: reading a first system time of the electronic device when the vibration sensor is activated.

6. The method as described in claim 5, further comprising:
calculating a difference between a second system time of the electronic device and the first system time of the electronic device, and detecting if the difference is the same as a predefined value;
detecting if the number of the activation times is the same as the predefined number when the difference is the same as the predefined value, and the screen of the electronic device remains in the locked state when the number of the activation times is different from the predefined times; and
detects if the vibration sensor is further activated when the difference is different from the predefined value, and increasing the activation times by one again when the vibration sensor is activated again.

7. A non-transitory storage medium having stored thereon instructions that, when executed by a processor, cause the processor to perform a method for unlocking a screen of an electronic device, the method comprising:
setting an initial value of an activation times of a vibration sensor of the electronic device;
increasing the activation times by one when a screen of the electronic device is in a locked state and the vibration sensor is activated; and
unlocking the screen when a number of the activation times is the same as a predefined number.

8. The non-transitory storage medium as described in claim 7, after the setting step further comprising: reading a first system time of the electronic device when the vibration sensor is activated.

9. The non-transitory storage medium as described in claim 8, further comprising:
calculating a difference between a second system time of the electronic device and the first system time of the electronic device, and detecting if the difference is the same as a predefined value;
detecting if the number of the activation times is the same as the predefined number when the difference is the same as the predefined value, and the screen of the electronic device remains in the locked state when the number of the activation times is different from the predefined times; and
detects if the vibration sensor is further activated when the difference is different from the predefined value, and increasing the activation times by one again when the vibration sensor is activated again.
